(19) United States
(12) Patent Application Publication
(10) Pub. No.: US 2014/0182371 A1
(43) Pub. Date: Jul. 3, 2014

(54) NON-RADIOACTIVE DENSITY MEASUREMENT IN OILFIELD OPERATIONS

(71) Applicant: SCHLUMBERGER TECHNOLOGY CORPORATION, Sugar Land, TX (US)

(72) Inventor: Edward Leugemors, Needville, TX (US)

(73) Assignee: Schlumberger Technology Corporation, Sugar Land, TX (US)

(21) Appl. No.: 13/727,890

(22) Filed: Dec. 27, 2012

(51) Int. Cl. G01N 9/26

(52) U.S. Cl. CPC G01N 9/26
USPC 73/32 R

(57) ABSTRACT

A densitometer system is described. The densitometer system is provided with a tube, a stand, a torsion measuring device and a data acquisition system. The tube has a first end, an inlet section at the first end of the tube, and an outlet section at the first end of the tube. The tube has a torque arm extending between the inlet section and the outlet section. The torque arm has a first section extending away from the first end and a second section extending toward the first end. The stand has a base and at least one leg connected to the base. The at least one leg is connected to the first end of the tube to support the tube a distance from the base. The torsion measuring device is connected to at least one of the inlet section and the outlet section of the tube. The torsion measuring device measures a quantity of torsion strain in the at least one of the inlet section and the outlet section. The data acquisition system calculating a density of fluid within the tube based upon the measured quantity of torsion strain.

### FIELD OF THE APPLICATION

The current application is generally related to measuring the density of an oilfield fluid during an oilfield operation, although embodiments disclosed herein may be applicable in other fields as well.

### BACKGROUND

The statements in this section merely provide background information related to the present disclosure and may not constitute prior art.

In oilfield operations such as sand control cementing and hydraulic fracturing it is generally desirable to constantly monitor the density of an oilfield fluid (such as proppant slurries) being pumped into the well. One approach to achieve this is to use a contact-based densitometer to directly measure the oilfield fluid being passed through a pipe or a container. The flow rate of the oilfield fluid is measured and the density of the oilfield fluid is then calculated. Equipment in this category includes, but is not limited to, mass flowmeters, hydrometers, etc. However, because the equipment is directly exposed to the oilfield fluid being measured, it is often susceptible for failure during oilfield operations due to the highly corrosive or highly abrasive nature of oilfield fluids.

Another approach is by using a non-contact densitometer to indirectly measure the oilfield fluid in a pipe or a container during an oilfield operation. The most widely used equipment in this category is the radioactive densitometer. It typically comprises a radiation source (such as radioactive cesium or cobalt) and a radiation detector. The radiation source is positioned on one side of a pipe or container and the radiation detector is positioned on the other side of the pipe or container. The radiation source emits radiation waves (such as gamma rays) and the radiation detector measures the attenuation of the radiation waves after they pass through the oilfield fluid. A processor then calculates the density of the oilfield fluid based on the signal detected. During the entire procedure, the radioactive densitometer does not contact the oilfield fluid being measured, hence the name “non-contact” densitometer.

One major disadvantage associated with using radioactive densitometers is the stringent regulations imposed by the government of various jurisdictions on the proper handling, transportation and storage of radioactive materials used in the radioactive densitometer. Accordingly, efforts have been made to use non-radioactive system to measure the density of oilfield fluids. For example, in one article, a Coriolis mass flowmeter was used to measure fluid densities. SPE23262, “Nonradioactive Densitometer for Continous Monitoring of Cement Mixing Process” (1991). However, the measuring tube in the Coriolis mass flowmeter can be eroded very quickly when the abrasive proppant slurries are pumped at a high rate through the flowmeter. Moreover, when the oilfield operation is to be conducted at high rates (such as 30 BPM or higher) and/or involving tubes with big diameters (such as 6 inches or higher), the Coriolis mass flowmeter quickly becomes large in size and highly expensive.

US Patent Application Publication No. 2008/0115577 discloses a method of manufacturing a high pressure vibrating tube densitometer comprising enclosing twin flow tubes within an outer shell where the outer shell comprises portals for the installation or replacement of internal components. US Patent Application Publication No. 2004/0007059 discloses a method of determining the concentration of a particulate added to a fluid stream comprising the steps of measuring the rate of flow of the fluid stream, determining the rate of particulate flow by using an acoustic sensor and then calculating the concentration of the particulate in the fluid stream using results from the measuring and determining steps.

There remains a need for a non-contact, non-radioactive densitometer that solves one or more of the above identified problems.

### SUMMARY

According to one aspect, there is provided a non-contact, non-radioactive densitometer system comprising a curved tube containing an oilfield fluid, a mass measuring device connected to the curved tube, and a data acquisition system connected to the mass measuring device. The mass measuring device measures the mass of the curved tube and the data acquisition system calculate the density of the oilfield fluid in the curved tube.

In one embodiment, the non-contact, non-radioactive densitometer system further comprises an antilog amplifier that is connected between the mass measuring device and the data acquisition system so that the antilog amplifier can transform the mass of the curved tube into an exponential value which is then fed into the data acquisition system.

In one embodiment, the non-contact, non-radioactive densitometer system transforms the mass of the curved tube into the exponential value by applying the following equation:

Iₒᵤₜ=a×Exp(b×m_{of}) (Equation III)
wherein,
   lₒᵤₜ is a signal output from the antilog amplifier;
   a and b are constants;
   m_{of} is the mass of the curved tube filled with the oilfield fluid minus the mass of the curved tube when empty.

The oilfield fluid can be proppant slurry. The curved tube can be substantially in the form of a “U” or “V” shape. Moreover, the curved tube may occupy a substantially horizontal plane. The mass measuring device can be a load cell such as an extension load cell. In one embodiment, the extension load cell is connected to a tripod on one end and to the curved tube on the other end.

According to another aspect, there is provided a method for measuring a density of an oilfield fluid. The method comprises providing a curved tube at an oilfield, filling the curved tube with an oilfield fluid, measuring the mass of the curved tube filled with the oilfield fluid, and calculating the density of the oilfield fluid. In one embodiment, the method further comprises conducting an exponential transformation of the mass of the curved tube filled with the oilfield fluid before calculating the density of the oilfield fluid, where the exponential transformation is performed by applying Equation III above.

According to another aspect of the application, there is provided a non-contact, non-radioactive densitometer apparatus, comprising a curved tube, a load cell connected to the curved tube, and a computer system connected to the mass measuring device. The load cell measures the mass of the curved tube and the data computer system calculate the density of an oilfield fluid contained in the curved tube.

In one embodiment, the non-contact, non-radioactive densitometer apparatus further comprises an antilog amplifier that is connected between the load cell and the computer system, where the antilog amplifier transforms the mass of the curved tube into an exponential value which is then fed into the data acquisition system. In one case, the exponential transformation is performed by applying the following Equation III above.

In another embodiment, a densitometer system is described. The densitometer system is provided with a tube, a stand, a torsion measuring device and a data acquisition system. The tube has a first end, an inlet section at the first end of the tube, and an outlet section at the first end of the tube. The tube has a torque arm extending between the inlet section and the outlet section. The torque arm has a first section extending away from the first end and a second section extending toward the first end. The stand has a base and at least one leg connected to the base. The at least one leg is connected to the first end of the tube to support the tube a distance from the base. The torsion measuring device is connected to at least one of the inlet section and the outlet section of the tube. The torsion measuring device measures a quantity of torsion strain in the at least one of the inlet section and the outlet section. The data acquisition system calculating a density of fluid within the tube based upon the measured quantity of torsion strain.

### BRIEF DESCRIPTION OF THE DRAWINGS

These and other features and advantages will be better understood by reference to the following detailed description when considered in conjunction with the accompanying drawings.

FIG. 1 is a schematic illustration of a prior art system utilizing a radioactive densitometer to measure the density of a target oilfield fluid.

FIG. 2 is a schematic illustration of a non-contact, non-radioactive densitometer system according to one embodiment of the current application.

FIG. 3 is a schematic illustration of a perspective view from the top of the non-contact, non-radioactive densitometer system according to one embodiment of the current application.

FIG. 4 is a schematic illustration of a perspective view from the side of the non-contact, non-radioactive densitometer system according to one embodiment of the current application.

FIG. 5 is a schematic illustration of the data output of the load cell in relation to the density of the oilfield fluid being measured, according to one embodiment of the current application.

FIG. 6 is a schematic illustration of the data output of the antilog amplifier in relation to the density of the oilfield fluid being measured, according to one embodiment of the current application.

FIG. 7 is a partial schematic top plan view of another example of a densitometer system constructed in accordance with the present disclosure.

FIG. 8 is a perspective view of a sensor device of the densitometer system constructed in accordance with the present disclosure.

FIG. 9 is a side elevation view of the sensor device constructed in accordance with the present disclosure for measuring a density of fluid.

FIG. 10 is a schematic diagram of a reader of the densitometer system of FIG. 7 that is configured to read the sensor device shown in FIGS. 8-9 in accordance with the present disclosure.

### DETAILED DESCRIPTION OF SOME ILLUSTRATIVE EMBODIMENTS

For the purposes of promoting an understanding of the principles of the current application, reference will now be made to the embodiments illustrated in the drawings and specific language will be used to describe the same. It will nevertheless be understood that no limitation of the scope of the application is thereby intended, any alterations and further modifications in the illustrated embodiments, and any further applications of the principles of the system, apparatus, and method as illustrated therein as would normally occur to one skilled in the art to which the current application relates are contemplated herein.

FIG. 1 shows a prior art system 100 where a radioactive densitometer 140 is used. As illustrated, the radioactive densitometer 140 may comprise a source component 140A and a detection component 140B. The source component 140A may contain one or more radioactive sources material 145, such as radioactive cesium or cobalt, and is positioned on one side of a pipe 110 through which an oilfield fluid 120 is delivered. The detection component 140B may contain one or more radioactive detectors and is positioned on the other side of the pipe 110 so that the radioactive signal emitted from the source component 140A can be detected by the detection component 140B after the signal is attenuated by the pipe 110 and the oilfield fluid 120. The detected signal can then be fed into a data acquisition system 180 such as a computer via a cable 150, where the density of the oilfield fluid 120 can be calculated and displayed.

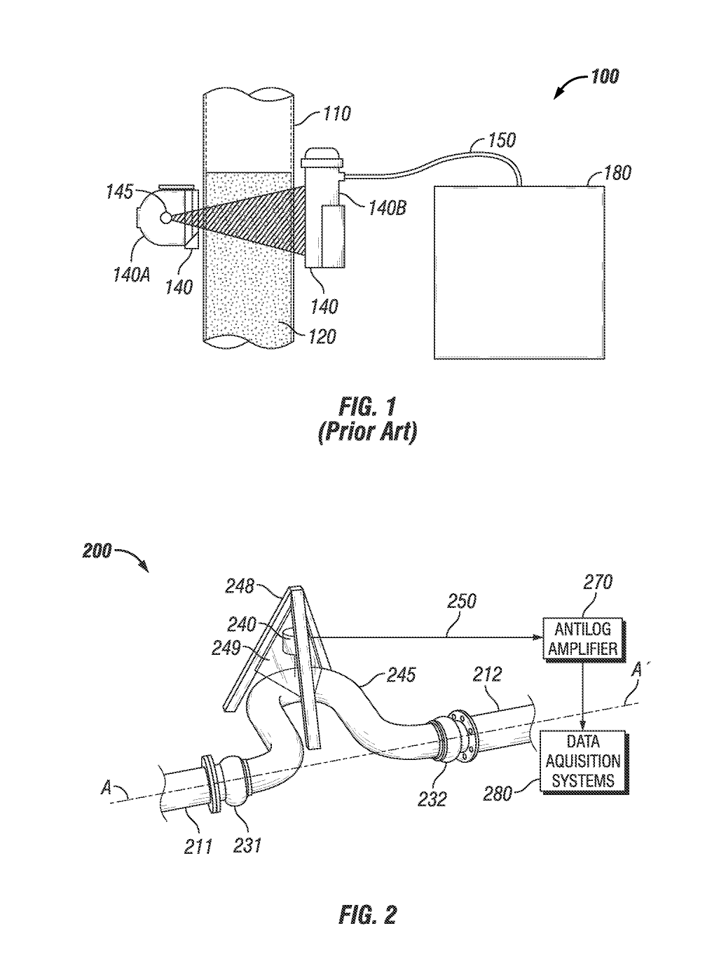

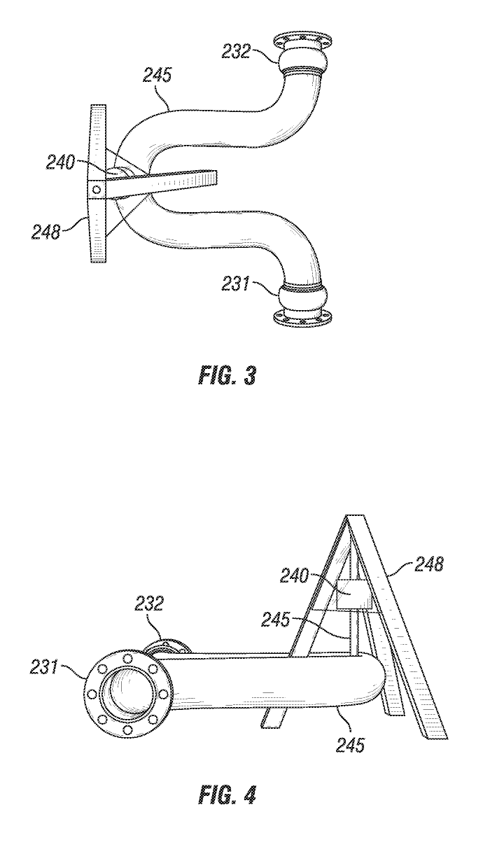

FIGS. 2-4 illustrate an exemplary non-contact, non-radioactive densitometer according to one aspect of the current application. System 200 comprises a curved tube 245, a mass measuring device 240 that is connected to the curved tube 245 and measures the mass of the curved tube 245, an antilog amplifier 270 that is connected to the mass measuring device 240 and transforms the data detected by the mass measuring device 240 from a linear curve to an exponential curve, and a data acquisition system 280 that is connected to the antilog amplifier 270 and calculates the density of the oilfield fluid that is contained in the curved tube 245.

As used in the current application, the term “fluid” should be constructed broadly to include any medium that is continuous and amorphous whose molecules are capable of moving freely past one another and that has the tendency to assume the shape of its container. A fluid can be a liquid, a gas, or a mixture thereof, which may further contain solids or solid particles suspended therein. Furthermore, as used in the current application, the term “oilfield fluid” should be interpreted broadly to include any fluid that may exist or be used at an oilfield during an oilfield operation, including, but not limited to, drilling, cementing, logging, stimulation, completion, production, and so on. Examples of “oilfield fluids” in the current application include, but are not limited to, proppant slurries, cement slurries, drilling fluids (often referred to as “mud”), hydraulic fracturing fluids, acid stimulation fluids, production fluids, and so on. In some cases, the fluid or oilfield fluid is air. In some other case, the fluid or oilfield fluid is water. In some further cases, the fluid or oilfield fluid is the cement slurry used in a cementing operation in the oilfield. In some cases the fluid consists of liquid and particles foamed with a gas such as air, nitrogen, carbon dioxide or other gases in gaseous or liquid form.

In the illustrated embodiment in FIGS. 2-4, the curved tube 245 is substantially in the form of a “U” shape. However, the curved tube 245 can be substantially in the form of a “V” shape, keyhole or other shapes readily perceivable by people skilled in the art after reviewing the disclosure of the current application. Moreover, in some cases, the mass measuring device 240 is connected to the substantially mid-point of curved tube 245. In some other cases, the mass measuring device 240 is connected to the curved tube 245 at a point that is substantially away from the mid-point of curved tube 245.

In the embodiment illustrated in FIGS. 2-4, the mass measuring device 240 is an extension load cell such as the 300 lbs Canister Load Cells that is supported by a tripod 248. However, it should be noted that other mass measuring devices such as spring scale and other supporting structure such as box frames or crossbars can also be used without departing from the teaching of the current application. In the embodiment illustrated in FIGS. 2-4, the extension load cell 240 can be positioned directly underneath the juncture of the three legs of the tripod 248. The mid-point of the curved tube 245 can be positioned directly underneath the extension load cell 240. In such a way, the juncture of the three legs of the tripod 248, the extension load cell 240, and the mid-point of curved tube 245 are substantially aligned with each other in the vertical direction.

Optionally, the tripod 248 may further comprise one or more covers 249 disposed between adjacent legs so that a hollow pyramidal space can be created in the tripod 248. The extension load cell 240 can be positioned inside the hollow pyramidal space, so that the potential impact by external factors (such as winds) on the extension load cell 240 can be minimized. In one particular example, the cover 249 is made of a transparent material, such as glass or clear plastic, so that the load cell can be readily inspected by a field operator from the outside of the tripod 248.

In another alternative embodiment, the mass measuring device 240 is a scale (not shown), a compression load cell (not shown), or any other devices that can measure the mass of an object resting on top of it. Therefore, the mass measuring device 240 in this embodiment can be placed underneath the curved tube 245 and measures the mass of the curved tube 245 from the bottom of the curved tube 245 instead of from the top, as in the case of using the extension load cell 240 as discussed above.

In one embodiment, an upstream pipe 211 is connected to a first end of the curved tube 245 via a first swivel joint 231, and a downstream pipe 212 is connected to a second end of the curved tube 245 via a second swivel joint 232. One example of the swivel joint is Chiksan® Series 2000 Swivel Joint-Carbon Steel, although other swivel joints can be used in the current application as well. After the connection, the curved tube 245 can rotate freely (or with little friction) along the longitudinal axis A-A′ defined by the upstream pipe 211 and downstream pipe 212. Therefore, the mass measuring device 240 is capable of measuring the mass equivalent of the torque that is created on the curved tube 245 with swivels on both ends.

The diameter of the curved tube 245 can be the same as the diameter of the upstream pipe 211 or downstream pipe 212, so as to minimize the potential impact by the change of flow path diameters to the reading of the mass measuring device 240. Alternatively, the diameter of the curved tube 245 can be different from the diameter of the upstream pipe 211 or downstream pipe 212, depending on the particular setting of an oilfield operation.

In some cases, the curved tube 245 can be made of the same material as that of the upstream pipe 211 or downstream pipe 212. In some other cases, the curved tube 245 can be made of a material that is of higher quality than that of the upstream pipe 211 or downstream pipe 212. Therefore, the corrosion resistivity, anti-washout capability, etc. of the curved tube 245 are the same as or higher than those of the upstream pipe 211 or downstream pipe 212, so that the lifespan of the curved tube 245 is at least the same as that of the upstream pipe 211 or downstream pipe 212. Other variations are possible depending on the particular setting of an oilfield operation.

In one embodiment, the curved tube 245 is positioned to occupy a substantially horizontal plane, best seen in FIG. 4. That is, the first end of the curved tube 245, the second end of the curved tube 245, and the mid-point of the curved tube 245 together define a plane that is substantially perpendicular to the gradient of the gravity field at the location of the oilfield operation. Alternatively, the curved tube 245 may be designed to occupy a plane that is tilted at an angle from the horizontal plane. All such variations are within the scope of the current application.

In operation, the volume of the curved pipe 245 can be determined by using the following equation:

V=[(m_{H2O}−mₐᵢᵣ)/(ρ_{H2O}−ρₐᵢᵣ)] (Equation I)

wherein,
V is the volume of the curved pipe 245;
mₐᵢᵣ is the mass measured by the mass measuring device 240 when the curved pipe 245 is completely empty;
m_{H2O} is the mass measured by the mass measuring device 240 when the curved pipe 245 is filled with pure water;

ρₐᵢᵣ is the density of air; and
ρ_{H2O} is the density of the pure water.
   For simplicity, ρₐᵢᵣ can be assumed to be zero pounds per gallon (PPG) and ρ_{H2O} can be assumed to be 8.34 pounds per gallon (PPG).

With the volume of the curved pipe 245 properly determined, the density of the oilfield fluid can be calculated as follows:

ρ_{of}=m_{of}/V (Equation II)

wherein,
V is the volume of the curved pipe 245;
m_{of} is the mass measured by the mass measuring device 240 when the curved pipe 245 is filled with an oilfield fluid minus the mass of the curved tube 245 when it is empty, e.g. mₐᵢᵣ; and
ρ_{of} is the density of the oilfield fluid.

To take advantage of the software and hardware currently used in the oilfield in association with the radioactive densitometer, in one further embodiment, the mass measuring device 240 is connected to an antilog amplifier 270 before it is connected to the data acquisition system 280, as illustrated in FIG. 2. Therefore, after the mass measuring device 240 obtains a reading on the mass of the curved tube 245, the mass measuring device 240 transmits the data to the antilog amplifier 270 where the data is transformed into an exponential value. For example, the data can be transformed by applying the following equation:

Iₒᵤₜ=a×Exp(b×m_{of}) (Equation III)

wherein,
Iₒᵤₜ is the signal coming out of the antilog amplifier 270;
a and b are constants;
m_{of} is the mass measured by the mass measuring device 240 when the curved pipe 245 is filled with an oilfield fluid minus the mass of the curved tube 245 when it is empty, e.g. mₐᵢᵣ.
   In one example, the antilog amplifier 270 is a Model AL500 Antilog Amplifier manufactured by Lee-Dickens Ltd. Other antilog amplifiers can be used in the current application as well.

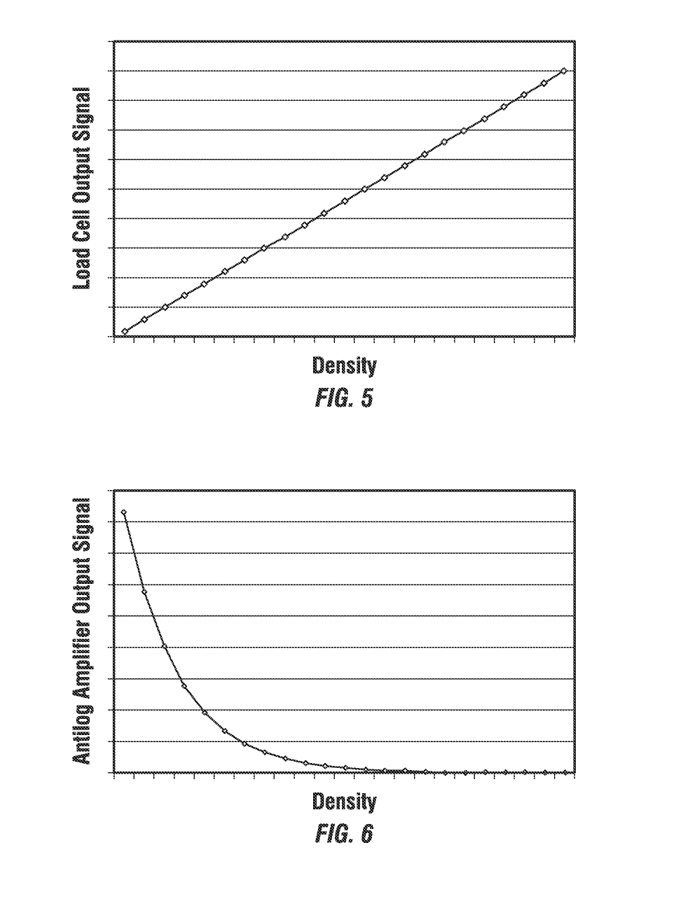

In this way, the data acquisition system 180 used in the prior art system 100 in association with the radioactive densitometer 140 (see FIG. 1) can be directly implemented in the current system 200 with little or no modification. This is because the radiation signal detected in the prior art system 100 is exponentially attenuated after it passes through the oilfield fluid, while the mass signal of the current system 200 remains proportional to the density of the oilfield fluid. By applying the antilog amplification, the mass signal of the current system 200 (as shown in FIG. 5 in the form of a linear curve) is transformed into an exponential signal (as shown in FIG. 6 in the form of an exponential curve). The exponential signal can then be fed into the prior art data acquisition system 180 and directly interpreted by the prior art data acquisition system 180. Therefore, significant cost saving can be achieved when switching from the radiation based densitometer system 100 as in the prior art to the non-radiation based densitometer system 200 as in the current application.

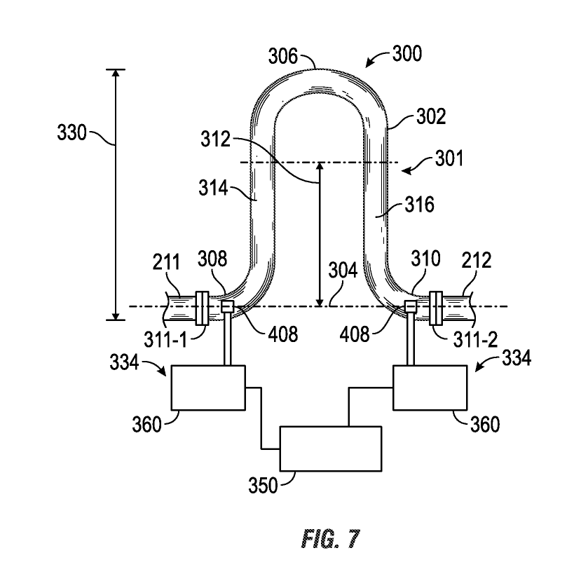

Referring now to FIGS. 7-10, shown therein is another example of a densitometer system 300 constructed in accordance with the present disclosure. In general, the densitometer system 300 is designed to determine a density of a fluid by measuring a quantity of torsion strain in a sensor device 301, which may include a cantilevered tube 302 (hereinafter “tube 302”) passing the fluid. The tube 302 can be constructed of a unitary pipe which has been bent or otherwise formed to have the inlet section 308, the outlet section 310 and the torque arm 312. Or, the tube 302 can be constructed of a plurality of pipe sections that have been interconnected to have the inlet section 308, the outlet section 310 and the torque arm 312. In general, the tube 302 has a first end 304, a second end 306, an inlet section 308 and an outlet section 310. The tube 302 may be constructed and supported in such a way that it is attached or supported only at the first end 304 such that gravity acts on the second end 306 of the tube 302 thereby applying a torque to the first end 304 and causing a variable amount of deflection of the second end 306 relative to the first end 304 depending upon the weight of the fluid passing through the tube 302. The quantity of deflection can be measured as discussed below and correlated to the density of the fluid.

In one embodiment, the inlet section 308 and the outlet section 310 are at the first end 304 of the tube 302. The inlet section 308 has a first connector 311-1 designed to connect to the upstream pipe 211 described above and the outlet section 310 has a second connector 311-2 designed to connect to the downstream pipe 212 such that fluid flowing in the upstream pipe 211 passes into the tube 302 via the inlet section 308, passes through the tube 302, exits the tube 302 through the outlet section 310 and passes into the downstream pipe 212. The first and second connectors 311-1 and 311-2 are designed to prevent rotation of the tube 302 relative to the upstream pipe 211 and the downstream pipe 212. For example, the first and second connectors 311-1 and 311-2 can be constructed of a flange having a pattern of holes to receive bolts for connecting the tube 302 to the upstream and downstream pipes 211 and 212.

To facilitate the deflection of the tube 302, the tube 302 has a torque arm 312 extending between the first end 304 and the second end 306. In general, the torque arm 312 may be a section of the tube 302 extending from the first end 304 (i.e., the centerline of the inlet section 308 and the outlet section 310) to the center of gravity of tube 302. The torque arm 312 is provided with a first section 314 extending away from the first end 304 and a second section 316 extending toward the first end 304. The first section 314 serves to convey the fluid away from the inlet section 308 at the first end 304 toward the second end 306 while the second section 316 serves to convey the fluid away from the second end 306 to the outlet section 310 at the first end 304.

The tube 302 can be constructed of a unitary pipe which has been bent or otherwise formed to have the inlet section 308, the outlet section 310 and the torque arm 312. Or, the tube 302 can be constructed of a plurality of pipe sections that have been interconnected to have the inlet section 308, the outlet section 310 and the torque arm 312.

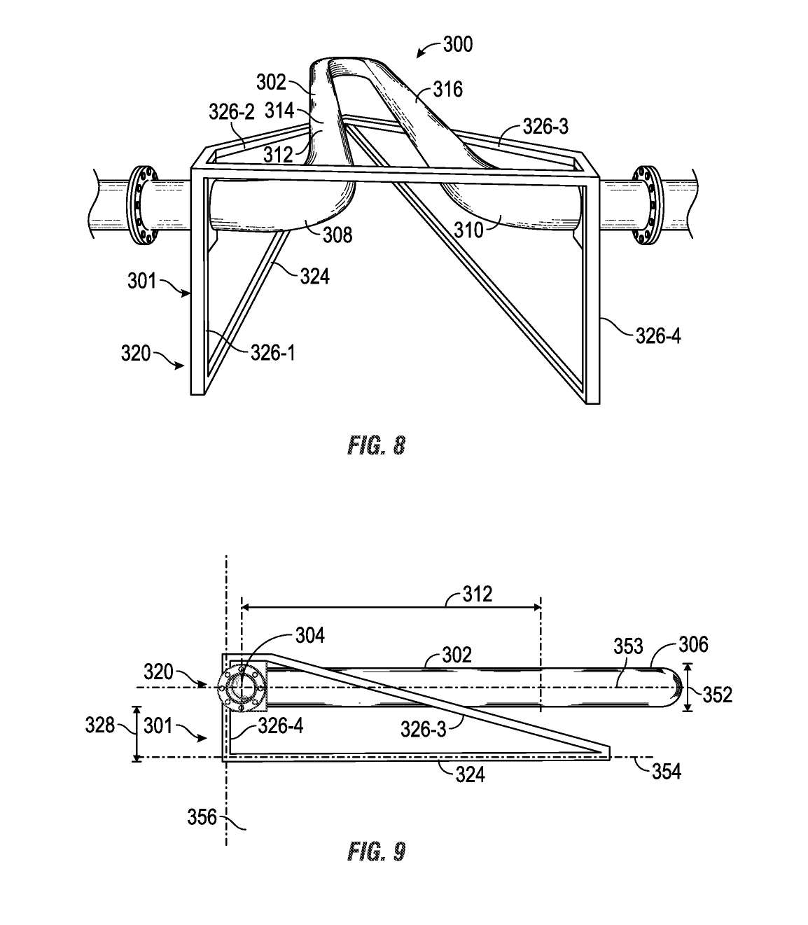

As shown in FIG. 8, to support the tube 302 at the first end 304, the sensor device 301 of the densitometer system 300 may be provided with a stand 320. The stand 320 has a base 324 and at least one leg 326 connected to the base 324 and extending vertically therefrom. In the example shown, the stand 320 is provided with legs 326-1, 326-2, 326-3 and 326-4. The at least one leg 326 is connected to the first end 304 of the tube 302 and serves to support the tube 302 a distance 328 away from the base 324.

The sensor device 301 may be provided as a composite unit in which the tube 302 is permanently attached to the stand 320 via welding or other suitable permanent connection. The tube 302 can be provided with any diameter suitable for receiving and passing the fluid at the particular location where the density of the fluid is going to be measured. For example, the tube 302 may be a diameter in a range from two inches to 20 inches. The tube 302 has a length 330 extending between the first end 304 and the second end 306. In general, increasing the length 330 of the tube 302 increases the sensitivity of the sensor device 301 to variations in the density of the fluid. However, increasing the length 330 of the tube 302 also increases the cost of the sensor device 301 and makes the sensor device 301 more difficult to transport. It has been found that the length may be in a range between 2-25 feet, and one suitable length has been found to be 20 feet. However, it should be understood that the length 330 can be varied depending upon the desired application of the sensor device 301. Further, it should be understood that the sensor device 301 may be mounted on a trailer to be moved between various job sites, which can be wellsites when it is desired to measure the density of an oil field fluid.

To measure the quantity of torsion strain in the tube 302, the densitometer system 300 may be provided with one or more torsion measuring device 334. The torsion measuring device 334 may be connected to at least one of the inlet section 308 and the outlet section 310 of the tube 302 and measures the quantity of torsion strain acting upon the tube 302 at the first end 304, e.g., at the inlet section 308 and/or the outlet section 310. The quantity of torsion strain acting upon the tube 302 is related to the weight of the tube 302 due to the density of the fluid passing through the tube 302. Thus, the output of the torsion measuring device 334 can be used to measure the density of the fluid passing through the tube 302. In general, the output of the torsion measuring device 334 may be a digital and/or analog signal having a value or magnitude indicative of the quantity of the torsion strain acting upon the tube 302.

To determine the density of the fluid passing through the tube 302, the densitometer system 300 is provided with a data acquisition system 350. The data acquisition system 350 receives the digital and/or analog signal having a value or magnitude indicative of the quantity of the torsion strain acting upon the tube 302 and then calculates the density of the fluid within the tube 302 based upon the measured quantity of the torsion strain. The data acquisition system 350 can be a computer having one or more processor running computer executable code adapted to receive the value or magnitude of the quantity of strain acting upon the tube 302 and to calculate the density of the fluid within the tube 302. The computer executable code can be stored in a non-transient computer readable medium, such as random access memory, flash memory, read only memory or the like. The computer readable medium can be implemented in variety of forms, such as a semiconductor chip(s), a magnetic hard drive, an optical hard drive, an optical disk or the like.

As shown in FIG. 7, the torque arm 312 may be substantially in the form of a “U” or “V” shape or keyhole so as to conveniently pass the fluid from the first end 304 of the tube 302 to the second end 306 of the tube 302. However, it should be understood that the torque arm 312 may be provided with other shapes the long as the torque arm 312 may receive and pass a sufficient amount of fluid to cause a measurable amount of torque acting at a rosette 408 that is discussed below at the inlet section 308 and outlet section 310 at the first end 304.

As best shown in FIG. 9, the torque arm 312 may occupy a first substantially horizontal plane 353 which is preferably leveled to be normal to the Earth's gravitational field so as to maximize the amount of gravitational force being applied to the torque arm 312. To support the torque arm 312 normal to the Earth's gravitational field, the base 324 may occupy a second substantially horizontal plane 354 that is substantially parallel to the first substantially horizontal plane 352. Thus, by leveling the base 324 the torque arm 312 will also be leveled relative to the gravitational force being applied to the torque arm 312. The at least one leg 326 may include the legs 326-1 and 326-4 that extend vertically, and legs 326-2 and 326-3 that form braces. In this instance, the legs 326-1 and 326-4 may occupy a vertical plane 356 that is substantially normal to the first and second substantially horizontal planes 353 and 354 to provide vertical support to the tube 302.

The tube 302 is made of a material having a memory and elastic qualities to function as a spring. For example, the tube 302 can be made of steel and in one embodiment is made of the same type of steel as the upstream pipe 211 and the downstream pipe 212. However, the tube 302 may be made of other materials, such as aluminum.

By only supporting the torque arm 312 by the first end 304, the tube 302 acts like a spring to flex downwardly as the weight of the fluid increases due to a higher density of the fluid and upwardly as the weight of the fluid decreases due to a lower density of the fluid. To ensure that the torque arm 312 deflects due to the quantity of torsion strain, the at least one leg 326 is connected to the first end 304 to restrict pivotation of the first end 304 relative to the at least one leg 326. For example, the at least one leg 326 may be welded or bolted to the first end 304. More particularly, in one embodiment, the inlet section 308 and the outlet section 310 are rigidly connected to the at least one leg 326 such that the inlet section 308 and the outlet section 310 provide vertical support to the torque arm 312. In other words, the torque arm 312 of the tube 302 may be cantilevered by the inlet section 308 and the outlet section 310 of the tube 302.

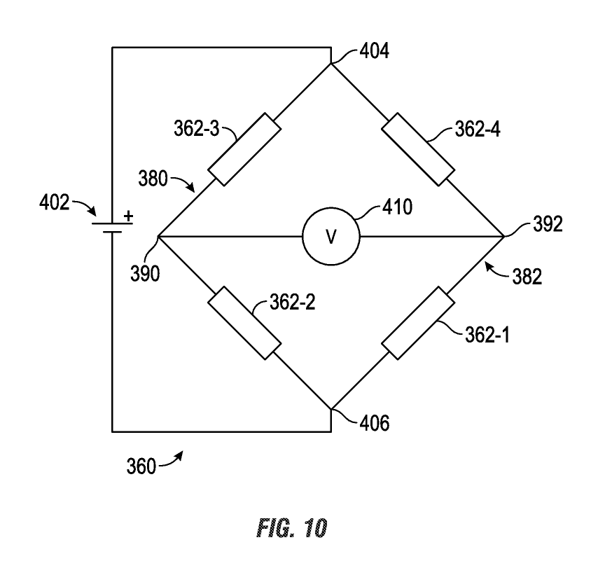

As discussed above, The torsion measuring device 334 may be connected to at least one of the inlet section 308 and the outlet section 310 of the tube 302 and measures the quantity of torsion strain acting upon the tube 302 at the first end 304, e.g., at the inlet section 308 and/or the outlet section 310. The torsion measuring device 334 may include a reader 360 having analog and/or digital circuitry supplying electricity to one or more strain sensor 362 mounted to at least one of the inlet section 308 and the outlet section 310. The strain sensors 362 may vary a first electrical property, such as resistance, due to distortion in the inlet section 308 or the outlet section 310, and the reader 360 may measure a second electrical property, such as voltage, induced by variations of the first electrical property. As shown in FIG. 10, the reader 360 and the strain sensor 362 may be components of a circuit 366 used to measure the quantity of torsion strain occurring in the tube 302.

As shown in FIG. 10, the circuit 366 may be in the form of a wheatstone bridge 368 having four strain sensor resistors 362-1, 362-2, 362-3 and 362-4 with known resistances prior to deformation coupled together in the fashion shown in FIG. 10. The wheatstone bridge 368 may be an electrical circuit used to measure changes from the known electrical resistances of the strain sensor resistors 362-1, 362-2, 362-3 and 362-4 by balancing two legs 380 and 382 of the wheatstone bridge 368. The leg 380 is formed by the strain sensor resistors 362-2 and 362-3; and the leg 382 is formed by the strain sensor resistor 362-1 and the resistor 362-4. The ratio of the resistances in the leg 380 (resistor 362-2/resistor 362-3 compared to the resistance in the leg 382 (strain sensor 362-1/resistor 362-4), represent the torsional strain of the inlet section 308 and/or the outlet section 310 where the wheatstone bridge 308 is mounted. When the wheatstone bridge 368 is properly mounted the noted comparison of the resistance in the legs 380 and 382 null out the longitudinal & hoop stress caused by pressure or temperature forces within the tube 302.

The reader 360 may include a signal source 402 that supplies a voltage to nodes 404 and 406, and a galvanometer 410 connected to the midpoints 390 and 392 to measure the voltage between midpoints 390 and 392. If the bridge is unbalanced, the direction of the current indicates whether the resistance of the strain sensor 362-1 is too high or too low. And, a magnitude of the voltage indicates the amount of torsion strain that is being applied to the torsion arm 312.

The wheatstone bridge 368 can be implemented as a rosette 408 having a substrate supporting the strain sensor resistors 362-1, 362-2, 362-3 and 362-4. The rosette 408 can be attached to the tube 302 in any suitable location, such as on the inlet section 308 or the outlet section 310. The location of attachment can be varied, but is desirably at the first end 304 where the largest amount of torsional strain occurs in the tube 302.

To obtain a more accurate reading of the torsion strain within the tube 302, two or more torsion measuring devices 334 can be used. In this case, a first torsion measuring device 334 may be connected to the inlet section 308 of the tube 302 to measure a first quantity of torsion strain in the inlet section 308, and a second torsion measuring device 334 may be connected to the outlet section 310 of the tube 302 to measure a second quantity of torsion strain in the outlet section 310. The readings by the two or more torsion measuring devices 334 can be averaged to provide a more accurate reading of the quantity of torsion strain within the tube 302 and thus a more accurate reading of the density of the fluid passing through the tube.

Using the wheatstone bridge 368 to calculate the density of the fluid leads to many benefits, such as a low mechanical hysteresis in using the tube 302 in torsion because of low losses due to the only losses being the working of the tube 302 to deflect the strain sensor resistors 362-1, 362-2, 362-3, and 362-4. Further, the rosette 408 may be a pure resistive element having very little hysteresis and a nearly instantaneous response time. In addition, the rosette 408 having the wheatstone bridge 368 configuration cancels hoop and axial strain induced by an internal pressure within the tube 302 of changes in temperature.

The following is a discussion of how to use the readings from the rosette 408 to determine inlet section 308 and outlet section 308 pipe torque strain and thus the density of the fluid within the tube 302.

Torque strain used in the calculation below to determine torque acting on the inlet section 308 and the outlet section 310 of the tube 302 by solving for T in the following equation:

TS=(192)(T)(Do)(1+v)/(pi)(Do⁴−Di⁴)(E) where

TS=torque strain

T=torque applied to the inlet and outlet pipe cross section

Do=outside diameter

v=poissons ratio for the pipe material

E=material modulus of elasticity (30×10⁶ psi for steel)

The torque value is then used in T=Fu×Lcg/2 and this is solved for Fu

Fu−force of empty pipe=force of mass in the tube 302. F of mass/gravity=mass of tube 302 contents.

tube 302 contents mass/volume of tube 302 contents=density of the measured fluid in the tube 302.

Where: T=torque applied to the inlet section 308 and outlet section 310 of tube 302.

In one embodiment, the systems 200 and/or 300 of the current application are deployed at an offshore location such as a vessel or an oil rig for conducting an oilfield operation offshore. In another embodiment, the systems 200 and/or 300 of the current application are deployed at a land or offshore location such as on a truck, on a skid, or simply on the ground of a wellsite, for conducting an oilfield operation on the land. Furthermore, in one embodiment, the systems 200 and/or 300 of the current application are deployed on the low pressure end (e.g. 0-200 psi) of an oilfield fluid system. In another embodiment, the systems 200 and/or 300 of the current application may be deployed on the high pressure end (e.g. 500-20,000 psi) of an oilfield fluid system. Other variations are also possible.

It should be noted that although the above description is set forth in the context of conducting a sand control operation in an oilfield, embodiments of the current application are also applicable to other oilfield operations including, but not limited to, cementing, drilling, hydraulic fracturing, logging, working over, acid or other stimulation, production, and so on. Moreover, embodiments of the current application may also be applicable to other industries as well, such as construction, manufacture, transportation, just to name a few.

The preceding description has been presented with reference to some illustrative embodiments of the current application. Persons skilled in the art and technology to which this application pertains will appreciate that alterations and changes in the described structures and methods of operation can be practiced without meaningfully departing from the principle, and scope of this application. Accordingly, the foregoing description should not be read as pertaining only to the precise structures described and shown in the accompanying drawings, but rather should be read as consistent with and as support for the following claims, which are to have their fullest and fairest scope.

Furthermore, none of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle. The claims as filed are intended to be as comprehensive as possible, and NO subject matter is intentionally relinquished, dedicated, or abandoned

What is claimed is:

1. A densitometer system, comprising:
a tube having a first end, an inlet section at the first end of the tube, and an outlet section at the first end of the tube, the tube having a torque arm extending between the inlet section and the outlet section, the torque arm having a first section extending away from the first end and a second section extending toward the first end;
a stand having a base and at least one leg connected to the base, the at least one leg connected to the first end of the tube to support the tube a distance from the base;
a torsion measuring device connected to at least one of the inlet section and the outlet section of the tube, the torsion measuring device measuring a quantity of torsion strain in the at least one of the inlet section and the outlet section;
a data acquisition system calculating a density of fluid within the tube based upon the measured quantity of torsion strain.

2. The densitometer system of claim 1, wherein the torsion measuring device includes a circuit having a signal source supplying electricity to a strain sensor mounted to at least one of the inlet section and the outlet section to vary a first electrical property due to distortion in the inlet section or the outlet section, and a reader measuring a second electrical property within the circuit induced by variations of the first electrical property.

3. The densitometer system of claim 2, wherein the first electrical property is resistance, and the second electrical property is voltage.

4. The densitometer system of claim 2, wherein the circuit further comprises a wheatstone bridge having four resistors with known resistances in circuit acting as the strain sensor.

5. The densitometer system of claim 1, wherein the torque arm is substantially in the form of a “U” or “V” shape.

6. The densitometer system of claim 1, wherein the torque arm occupies a substantially horizontal plane.

7. The densitometer system of claim 1, wherein the substantially horizontal plane is a first substantially horizontal plane, and wherein the base occupies a second substantially horizontal plane substantially parallel to the first substantially horizontal plane.

8. The densitometer system of claim 1, wherein the torque arm is only supported by the first end.

9. The densitometer system of claim 1, wherein the at least one leg is connected to the first end to restrict pivotation of the first end relative to the at least one leg.

10. The densitometer system of claim 1, wherein the torsion measuring device is a first torsion measuring device connected to the inlet section of the tube to measure a first quantity of torsion strain in the inlet section, and further comprising a second torsion measuring device connected to the outlet section of the tube to measure a second quantity of torsion strain in the outlet section.

11. The densitometer system of claim 10, wherein the data acquisition system averages the first quantity of torsion strain and the second quantity of torsion strain and calculates the density of fluid within the tube based upon the average quantity of torsion strain.

12. A method, comprising:
passing a fluid through a cantilevered tube only being supported at a first end;
measuring a torsion strain of the tube due to an application of torque in opposite directions at the first end and a second end of the tube; and
calculating a density of the fluid passing through the tube using a measurement of the torsion strain.

13. The method of claim 12, wherein the tube comprises an inlet section and an outlet section at the first end of the tube, and wherein, prior to the step of passing fluid through the tube, the method further comprises the steps:
connecting an upstream pipe to the inlet section with a first non-pivoting connector; and
connecting a downstream pipe to the outlet section with a second non-pivoting connector.

14. A method, comprising:
forming a tube such that the tube has an inlet section, an outlet section and a torque arm, the inlet section and the outlet section being aligned with a first longitudinal axis, the torque arm having a second longitudinal axis that is not parallel with the first longitudinal axis;
connecting the inlet section and the outlet section to a stand such that the torque arm is suspended by the inlet section and the outlet section a distance away from a base of the stand;
applying a first strain sensor of a first torsion measuring device to the inlet section; and
applying a second strain sensor of a second torsion measuring device to the outlet section.

15. The method of claim 14, wherein the step of forming is defined further as forming the torque arm into a substantially “U” or “V” shape.

16. The method of claim 14 wherein the step of forming is defined further as forming the torque arm such that the second longitudinal axis is substantially normal to the first longitudinal axis.

17. The method of claim 14, wherein the step of connecting the inlet section and the outlet section to the stand is defined further as connecting the inlet section and the outlet section to the stand such that the torque arm occupies a substantially horizontal plane.

18. The method of claim 14, wherein the step of connecting the inlet section and the outlet section to the stand is defined further as connecting the inlet section and the outlet section to the stand such that the inlet section and the outlet section provide vertical support to the torque arm.

19. The method of claim 18, wherein the step of connecting the inlet section and the outlet section to the stand is defined further as connecting the inlet section and the outlet section to the stand such that the torque arm is cantilevered by the inlet section and the outlet section.

20. A sensor device, comprising:
a tube having a first end, an inlet section at the first end of the tube, and an outlet section at the first end of the tube, the tube having a torque arm extending between the inlet section and the outlet section, the torque arm having a first section extending away from the first end and a second section extending toward the first end; and
a stand having a base and at least one leg connected to the base, the at least one leg connected to the first end of the tube to support the tube a distance from the base.

21. The sensor device of claim 20, wherein the torque arm occupies a substantially horizontal plane.

22. The sensor device of claim 20, wherein the substantially horizontal plane is a first substantially horizontal plane, and wherein the base occupies a second substantially horizontal plane substantially parallel to the first substantially horizontal plane.

23. The sensor device of claim 20, wherein the torque arm is only supported by the first end.

24. The sensor device of claim 20, wherein the at least one leg is connected to the first end to restrict pivotation of the first end relative to the at least one leg.
